(19) United States
(12) Patent Application Publication
(10) Pub. No.: US 2014/0111796 A1
(43) Pub. Date: Apr. 24, 2014

(54) SYSTEM AND METHOD FOR MEASURING ECCENTRICITY OF FIBER LENS DEVICE

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 13/693,050

(22) Filed: Dec. 4, 2012

(30) Foreign Application Priority Data
Oct. 18, 2012 (TW) 101138354

(51) Int. Cl. G01M 11/02

(52) U.S. Cl. CPC G01M 11/0221
USPC 356/127

(57) ABSTRACT

A system for measuring an eccentricity of a fiber lens device includes a measuring fixture, an image capturing device and an analysis device. The fiber lens device includes a lens and a fiber receiving hole. The measuring fixture includes a measuring surface defining an insertion hole and three measuring holes arranged in vertexes of an equilateral triangle. The measuring fixture further includes a rod in the insertion hole. A circumcenter of the equilateral triangle formed by the three measuring hole is concentric with the rod, and the rod is configured for being inserted into the fiber receiving hole. The image capturing device is configured for capturing an image of the measuring fixture and the fiber lens device. The analysis device is configured for analyzing the image to acquire a distance between the circumcenter and a center of the lens, and determining whether the distance is in a predetermined range.

### BACKGROUND

1. Technical Field

The present disclosure relates to eccentricity measurements, and particularly, to a system and a method for measuring an eccentricity of a fiber lens device.

2. Description of Related Art

FIG. 1 shows a fiber lens device 10. The fiber lens device 10 defines a hole 11 and a fiber receiving hole 13 at two opposite ends respectively. The fiber lens device 10 includes a lens 12 in the hole 11. The lens 12 must be aligned with the fiber receiving hole 13. When in use, an optical fiber (not shown) is inserted into the fiber receiving hole 13. An optical signal is transmitted from the optical fiber to the lens 12, or vice verso. Yet, eccentricity usually exists between the lens 12 and the fiber receiving hole 13, which will cause a loss of the optical signal. If the eccentricity is too much, the fiber lens device 10 will become useless.

Therefore, it is desired to provide a system and a method for measuring the eccentricity between a lens and a fiber receiving hole of a fiber lens device.

### BRIEF DESCRIPTION OF THE DRAWINGS

FIG. 1 is a schematic, sectional view of a fiber lens device in related art.

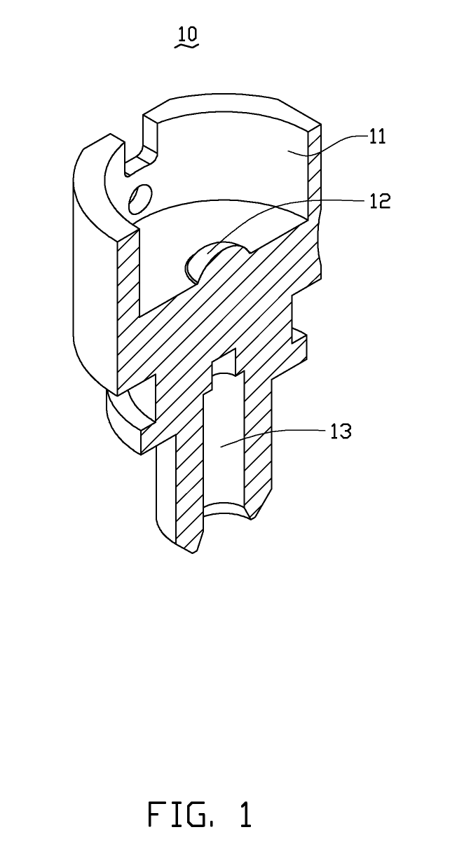

FIG. 2 is a schematic, isometric view of a system for measuring an eccentricity of the fiber lens device of FIG. 1 according to an embodiment, the system including a measuring fixture.

FIG. 3 is a schematic, isometric view of the measuring fixture.

FIG. 4 is a flow chart of a method for measuring the eccentricity of the fiber lens device according to another embodiment.

### DETAILED DESCRIPTION

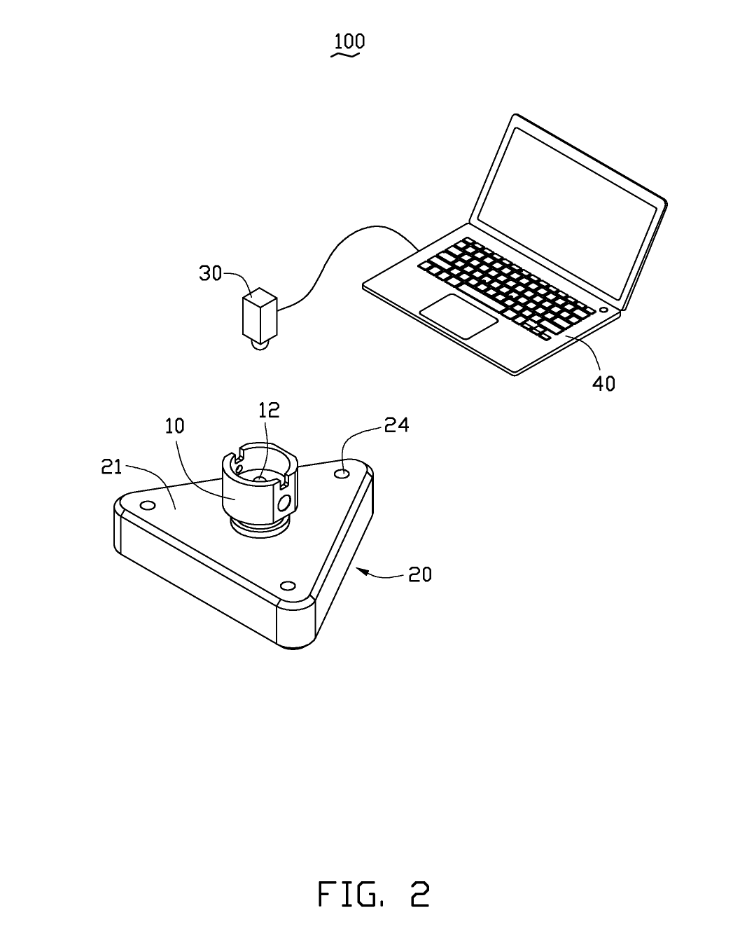

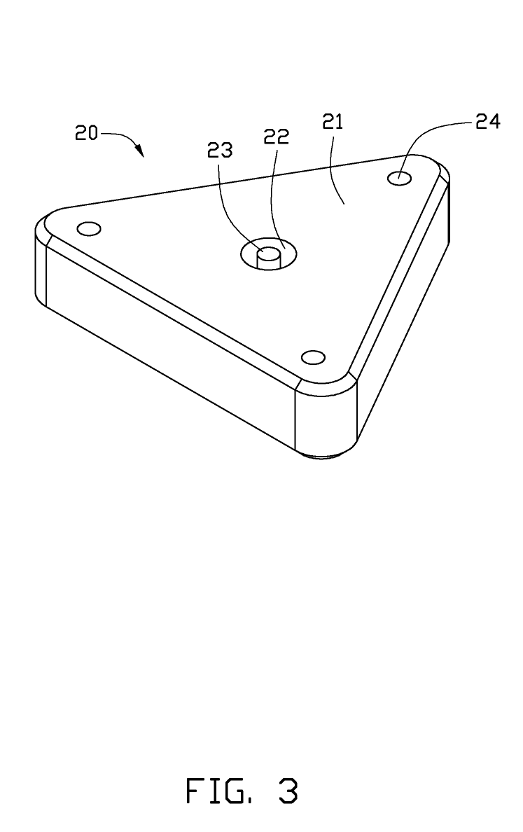

FIGS. 2 to 3 show a system 100 for measuring the eccentricity of the fiber lens device 10. The system 100 includes a measuring fixture 20, an image capturing device 30 and an analysis device 40.

The measuring fixture 20 is substantially a triangular block, and includes a measuring surface 21. The measuring surface 21 defines an insertion hole 22. The measuring fixture 20 includes a rod 23 in the insertion hole 22. The shape and size of the rod 23 is the same as that of an end of an optical fiber (not shown), and is also the same as that of the fiber receiving hole 13 of the fiber lens device 10. The rod 23 is inserted into the fiber receiving hole 13.

The measuring surface 21 further defines three measuring holes 24. The three measuring holes 24 are respectively positioned on three vertexes of an equilateral triangle and a circumcenter of the equilateral triangle is concentric with the rod 23.

The image capturing device 30 is used to capture an image of the measuring fixture 20 and the fiber lens device 10 connected to the measuring fixture 20. In this embodiment, the image capturing device 30 is a digital camera.

The analysis device 40 acquires the image captured by the image capturing device 30, analyzes the image to determine the position of the three measuring holes 24 and the center of the lens 12, calculates the circumcenter of the equilateral triangle formed by the three measuring holes 24. The circumcenter is concentric with the center of the fiber receiving hole 13. The analysis device 40 further calculates a distance between the circumcenter of the equilateral triangle and the center of the lens 12. The distance is the eccentricity of the fiber lens 10. The analysis device 40 further determines whether the eccentricity is in a predetermined range. If the eccentricity is in the predetermined range, the analysis device 40 determines that the fiber lens device 10 is qualified. If the eccentricity is out of the predetermined range, the analysis device 40 determines that the fiber lens device 10 is unqualified. In this embodiment, the analysis device 40 is a computer.

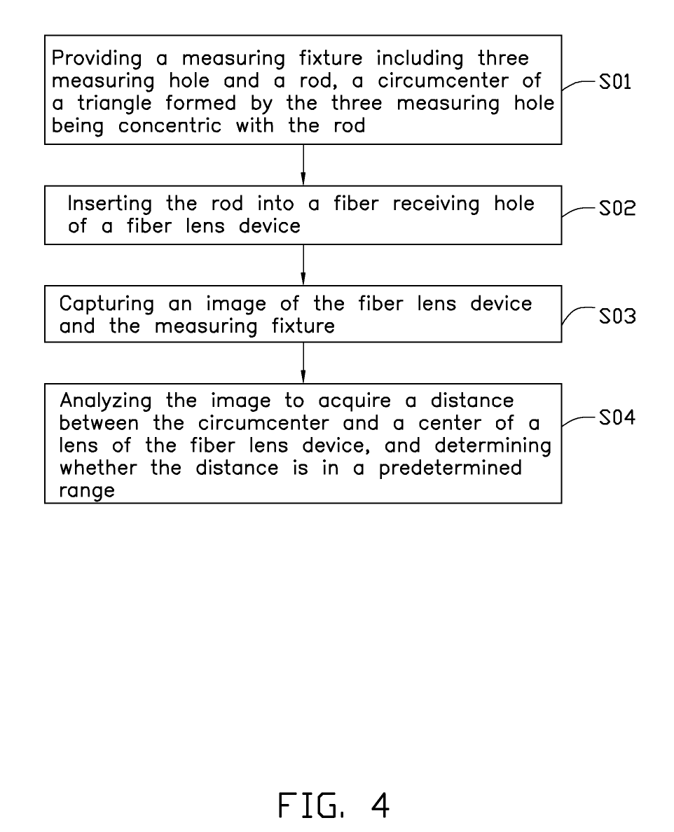

FIG. 4 shows a method for measuring the eccentricity of the fiber lens device 10, according to an embodiment. The method includes steps described as follows.

In step S01, a system 100 for measuring the eccentricity of the fiber lens device 10 is provided.

In step S02, the rod 23 is inserted into the fiber receiving hole 13 of the fiber lens device 10.

In step S03, the image of the measuring fixture 20 and the fiber lens device 10 is captured by the image capturing device 30.

In step S04, the image captured is analyzed by the analysis device 40 to determine whether the eccentricity between the lens 12 and the fiber receiving hole 13 is in the predetermined range. In detail, the analysis device 40 analyzes the image to determine the position of the three measuring holes 24 and the center of the lens 12, calculates the circumcenter of the equilateral triangle formed by the three measuring holes 24, calculates the distance between the circumcenter and the center of the lens 12. The analysis device 40 further determines whether the distance is in the predetermined range. If the distance is in the predetermined range, the analysis device 40 determines that the fiber lens device 10 is qualified. If the distance is out of the predetermined range, the analysis device 40 determines that the fiber lens device 10 is unqualified.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A system for measuring an eccentricity of a fiber lens device, the fiber lens device comprising a lens and defining a fiber receiving hole, the system comprising:
a measuring fixture comprising a measuring surface, the measuring surface defining an insertion hole and three measuring holes, the three measuring holes arranged in vertexes of an equilateral triangle, the measuring fixture further comprising a rod in the insertion hole, wherein a circumcenter of the equilateral triangle formed by the three measuring hole is concentric with the rod, and the rod is configured for being inserted into the fiber receiving hole;
an image capturing device configured for capturing an image of the measuring surface and the fiber lens device; and
an analysis device in communication with the image capturing device, the analysis device configured for analyzing the image to acquire a distance between the circumcenter of the equilateral triangle formed by the three measuring hole and a center of the lens, and determining whether the distance is in a predetermined range.

2. The system of claim 1, wherein the measuring fixture is substantially a triangular block.

3. The system of claim 1, wherein the analysis device is configured for determining the positions of the three measuring holes and the lens, and calculating the position of the circumcenter according to the positions of the three measuring holes.

4. The system of claim 1, wherein the image capturing device is a digital camera.

5. The system of claim 1, wherein the analysis device is a computer.

6. A method for measuring an eccentricity of a fiber lens device, the fiber lens device comprising a lens and defining a fiber receiving hole, the method comprising:
providing a system, the system comprising a measuring fixture, an image capturing device and an analysis device, the measuring fixture comprising a measuring surface, the measuring surface defining an insertion hole and three measuring holes, the three measuring holes arranged in vertexes of an equilateral triangle, the measuring fixture further comprising a rod in the insertion hole, a circumcenter of the equilateral triangle formed by the three measuring hole being concentric with the rod;
inserting the rod into the fiber receiving hole;
capturing an image of the measuring surface and the fiber lens device by using the image capturing device; and
analyzing the image by using the analysis device to acquire a distance between the circumcenter of the equilateral triangle formed by the three measuring hole and a center of the lens, and to determine whether the distance is in a predetermined range.

7. The method of claim 6, further comprising: determining the positions of the three measuring holes and the lens, and calculating the position of the circumcenter according to the positions of the three measuring holes in the step of analyzing the image.
